(19) United States
(12) Patent Application Publication
(10) Pub. No.: US 2019/0219204 A1
(43) Pub. Date: Jul. 18, 2019

(54) Support Sleeve

(71) Applicant: ContiTech MGW GmbH, Hannoversch Muenden (DE)

(72) Inventor: Hartmut Brill, Bad Sooden-Allendorf (DE)

(21) Appl. No.: 16/319,220

(22) PCT Filed: May 16, 2017
(86) PCT No.: PCT/EP2017/061686

§ 371 Date: Jan. 18, 2019

(30) Foreign Application Priority Data
Jul. 19, 2016 (DE) 10 2016 213 148.6

(51) Int. Cl. F16L 33/00

(52) U.S. Cl. CPC F16L 33/006

(57) ABSTRACT

A support sleeve reinforces yielding pipes, in particular plastic pipes, in the clamping region of a fastening bracket. The invention is based on the object of improving a support sleeve of the type mentioned at the outset so that the support sleeve remains securely in place in the interior of the plastic pipe even in the case of diameter variations of the plastic pipe without any complex preliminary deforming being necessary such that the support sleeve is capable of being fixed in the pipe end by way of a simple snap-fit. The support sleeve is configured as a pipe portion, wherein the pipe portion has notches so that each notch has a resilient tongue-shaped portion which at one side is resiliently connected to the support sleeve and which at the end thereof that is opposite the connection point to the support sleeve, protrudes radially beyond the external diameter of the support sleeve, pointing outward such that the tongue-shaped portion has a pawl-type shape.

### CROSS REFERENCE TO RELATED APPLICATIONS

This application is the national stage of PCT/EP2017/061686, filed May 16, 2017, designating the United States and claiming priority from German patent application no. 10 2016 213 148.6, filed Jul. 19, 2016, the entire contents of which are incorporated herein by reference.

### FIELD OF THE INVENTION

The invention relates to a support sleeve for reinforcing yielding pipes, in particular plastic pipes in the clamping region of a fastening bracket.

### BACKGROUND OF THE INVENTION

Plastic pipes are increasingly used as fluid lines in the automotive industry, in particular in the field of engines.

Polyamide is widely used herein as a plastics material. Connections to hoses that lead onward are often required in the end region of the pipes, wherein the hoses are capable of being fastened on the pipes inter alia by clamping brackets or tension brackets.

It is unavoidable herein that a radial compressive stress acts on the pipes, the radial compressive stress leading to an elastic deformation of the pipes. A plastic deformation or rupturing can also arise in the most extreme case. In order for this to be avoided, support sleeves which in most instances are made from metal, can be inserted into the respective pipe ends which prevents any impermissible deformation of the pipes during assembly. Plastic pipes are often subjected to varying temperature and humidity conditions during storage and transportation, this potentially leading to a widening of the pipes. It is possible herein for the mostly interference-fit based holding forces between the plastic pipe and the support sleeve to be cancelled herein and for the support sleeve to drop out.

A helical support element which solves this problem in that the element by way of a rotary variation of the helical shape of the support element is capable of being elastically reduced to an external diameter that fits into a respective pipe end is disclosed in DE 1775686A. The element expands again in the pipe end, such that the entire external diameter of the element bears on the inside of the plastic pipe. A reverse deformation in the event of an impingement of the plastic pipe by a force is not to be expected by virtue of friction effects.

However, this solution is associated with a relatively high complexity in production. Moreover, the elastic reduction in the circumference of the support element during assembly is rather complex. Simple push-fitting of such a support sleeve is possible only by way of additional preliminary deformation steps.

### SUMMARY OF THE INVENTION

It is an object of the invention to provide a support sleeve of the type mentioned at the outset in such a manner that the support sleeve remains securely in place in the interior of the plastic pipe even in the case of diameter variations of the plastic pipe without any complex preliminary deforming being necessary such that the support sleeve is capable of being fixed in the pipe end by way of a simple snap-fit.

This object is achieved in that the support sleeve is configured in the form of a pipe portion wherein the pipe portion has notches in such a manner that each notch has a resilient tongue-shaped portion which at one end is resiliently connected to the support sleeve and which at the end thereof that is opposite the connection point to the support sleeve has an end edge which, protruding radially beyond the external diameter of the support sleeve, points outward such that the tongue-shaped portion has a pawl-type shape.

A pawl-type tongue of this type expands in relation to the internal diameter of the plastic pipe and, by virtue of the resilient effect of the pawl-type tongue, equalizes variations in the diameter of the plastic pipe. A blocking effect is thus maintained across a large diameter range.

In one embodiment of the invention the tongue-shaped portions have a rectangular shape, wherein the end edges have a width that is exactly as wide as the width of the connection point to the support sleeve.

In one embodiment of the invention the tongue-shaped portions have a trapezoidal shape, wherein the end edges have a width that is narrower than the width of the connection point to the support sleeve.

A spring tension in the notch which is distributed in an almost uniform manner across the entire notch is achievable on account of this trapezoidal configuration of the notch. The larger width of the notch in the region of the resilient connection point has the effect that kinking of the notch is avoidable.

In one embodiment of the invention the tongue-shaped portions have a trapezoidal shape, wherein the end edges have a width that is wider than the width of the connection point to the support sleeve.

This arrangement has the advantage that a lower spring tension of the notches is achievable in the case of more delicate configurations of the plastic pipe. At the same time, a lower surface contact pressure per unit area is achievable on account of the larger width of the end edge of the notch that is supported on the plastic pipe.

In one embodiment of the invention the notch at the end thereof that faces away from the connection point to the support sleeve has a radially inward pointing curvature.

The holding effect of the pawl is indeed reduced on account of a curvature of this type, but the advantage lies in that any risk of injury by the internal surface of the plastic pipe is minimized on account of the rounded finish of the pawl in relation to the plastic pipe.

### BRIEF DESCRIPTION OF THE DRAWINGS

The invention will now be described with reference to the drawings wherein:

FIG. 1 shows a support sleeve according to the invention in the installed state and in a partial longitudinal section;

FIG. 2 shows the support sleeve according to the invention in an axial plan view; and,

FIG. 3 shows a support sleeve according to the invention, having an end-side curvature, in a partial longitudinal section.

### DESCRIPTION OF THE PREFERRED EMBODIMENTS OF THE INVENTION

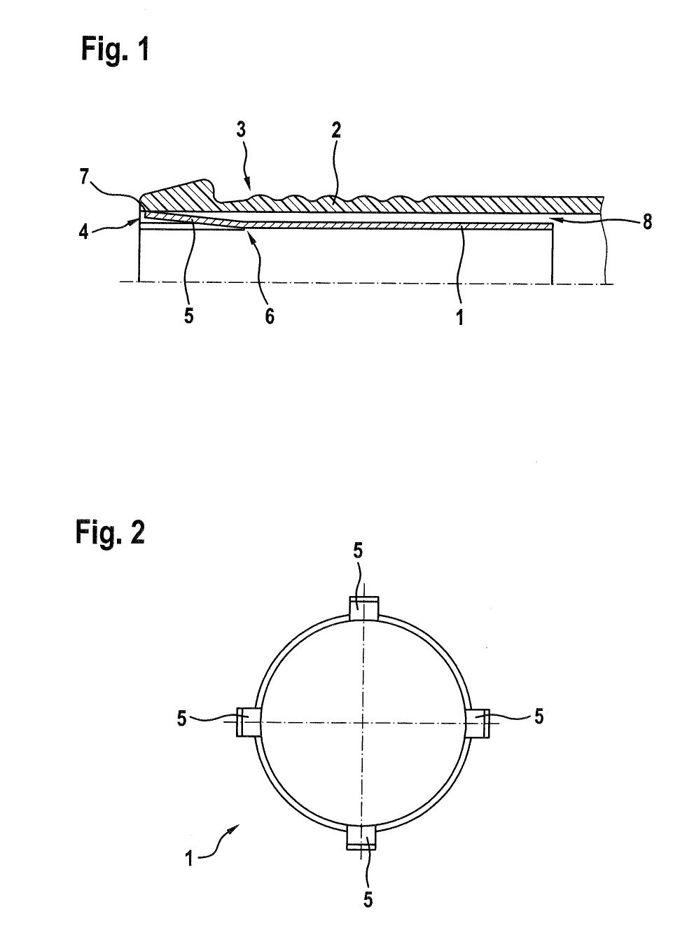

The support sleeve 1 shown in FIG. 1 is push-fitted into a plastic pipe 2. The plastic pipe 2 on the external circumference thereof has a profile 3 for fastening a hose (not shown here) having a bracket (likewise not shown here). The support sleeve 1 at a first end 4 of the support sleeve 1 has a tongue-shaped notch 5. The notch 5 at one end 6 is resiliently connected to the support sleeve 1; the notch 5 at the opposite end, protruding radially beyond the external diameter of the support sleeve 1, points outward and, by way of the end edge 7 of the notch 5, is supported on the plastic pipe 2. On account of the spring effect of the connection 6, a gap 8 between the support sleeve 1 and the plastic pipe 2 is capable of being bridged by the notch 5.

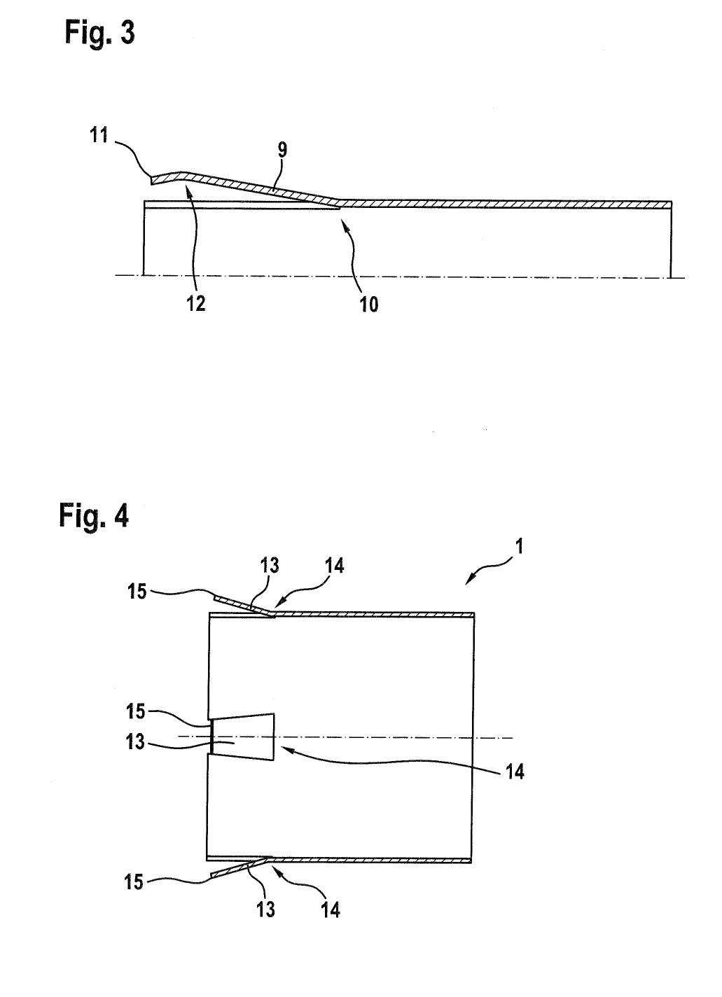

The support sleeve 1 is shown in an axial plan view in FIG. 2. The support sleeve 1 has four notches 5 which project outward in a resilient manner.

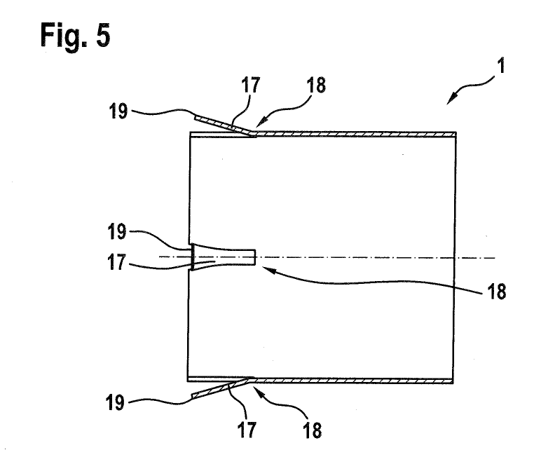

A notch 9 is shown in FIG. 3, the end 11 of the notch 9 that lies opposite a resilient connection 10 having a radially inward directed curvature 12. The relatively sharp-edged end 11 thus does not come into contact with a plastic pipe (not shown here).

The support sleeve 1 in FIG. 4 has four tongue-shaped notches 13 which have a trapezoidal shape, wherein the notches 13 at one end 14 are resiliently connected to the support sleeve 1, and the notches 13 at that end that lies opposite the end 14 have an end edge 15, wherein the end edge 15 is narrower than the resilient connection 14. Only three notches 13 are visible in this illustration.

A spring tension in the notch 13 which is distributed in an almost uniform manner across the entire notch 13 is achievable on account of this trapezoidal configuration of the notch 13. The larger width of the notch 13 in the region of the resilient connection 14 has the effect that kinking of the notch 13 is avoidable.

The support sleeve 1 in FIG. 5 has four tongue-shaped notches 17 which have a trapezoidal shape, wherein the notches 17 at one end 18 are resiliently connected to the support sleeve 1, and the notches 17 at that end that lies opposite the end 18 have an end edge 19, wherein the end edge 19 is wider than the resilient connection 18. Only three notches 17 are visible in this illustration.

This arrangement has the advantage that lower spring tensions of the notches 17 are achievable in the case of more delicate configurations of the plastic pipe 2 (not shown here). At the same time, a lower surface contact pressure per unit area between the end edge 19 and the plastic pipe 2 is achievable on account of the larger width of the end edge 19 (of the notch 17) that is supported on the plastic pipe 2 (not shown).

It is understood that the foregoing description is that of the preferred embodiments of the invention and that various changes and modifications may be made thereto without departing from the spirit and scope of the invention as defined in the appended claims.

### LIST OF REFERENCE NUMERALS

### (Part of the Description)

1 Support sleeve
2 Plastic pipe
3 Profile of the plastic pipe 2
4 First end of the support sleeve 1
5, 13, 17 Notch
6, 14, 18 Connection between the notch 5 and the support sleeve 1
7, 15, 19 End edge of the notch 5
8 Gap between the support sleeve 1 and the plastic tube 2
9 Notch having a curvature
10 Resilient connection between the notch 9 and the support sleeve
11 Sharp-edged end of the notch 9
12 Curvature of the notch 9

1-5. (canceled)

6. A support tube for a yielding pipe having a clamping region for a fastening bracket, the support tube being provided to reinforce the yielding pipe in the clamping region and the support tube comprising:
a support sleeve configured as a pipe section having an outer diameter;
a plurality of notches having respective resilient tongue-shaped sections;
each of said tongue-shaped sections having a first end whereat the tongue-shaped section is resiliently connected to said support sleeve;
the tongue-shaped section and said support sleeve conjointly defining a connection location at said first end whereat the tongue-shaped section is connected to the support sleeve;
each of said tongue-shaped sections having a second end lying opposite said first end;
each of said tongue-shaped sections having an end edge at the second end thereof; and,
said end edge being directed radially outwardly beyond said outer diameter so as to cause the tongue-shaped section to have a pawl-like shape.

7. The support sleeve of claim 6, wherein each of said tongue-shaped sections has a rectangular shape; and, the end edge thereof has a width that is exactly as wide as the width of said connection location to the support sleeve.

8. The support sleeve of claim 6, wherein each of said tongue-shaped sections has a trapezoidal shape; and, the end edge has a width that is less than the width of said connection location to the support sleeve.

9. The support sleeve of claim 6, wherein each of said tongue-shaped sections has a trapezoidal shape; and, the end edge thereof has a width that is greater than the width of the connection location to the support sleeve.

10. The support sleeve of claim 6, wherein each of said tongue-shaped sections has a radially inward directed curvature at the region of the second end thereof.

11. The support sleeve of claim 6, wherein the yielding pipe is made of plastic.
